(19) United States
(12) Patent Application Publication
(10) Pub. No.: US 2015/0382409 A1
(43) Pub. Date: Dec. 31, 2015

(54) SEQUENTIAL LINEAR LED DRIVER UTILIZING HEADROOM CONTROL

(71) Applicant: Microchip Technology Inc., Chandler, AZ (US)

(72) Inventors: Scott Lynch, Half Moon Bay, CA (US); Benedict Choy, Cupertino, CA (US)

(21) Appl. No.: 14/748,118

(22) Filed: Jun. 23, 2015

Related U.S. Application Data
(60) Provisional application No. 62/018,532, filed on Jun. 28, 2014.

(51) Int. Cl. H05B 33/08

(52) U.S. Cl. CPC H05B 33/083; H05B 33/0845

(57) ABSTRACT

A sequential linear light emitting diode (LED) driver utilizing a headroom control technique is disclosed.

### CROSS REFERENCE TO RELATED APPLICATION

This patent application claims priority to U.S. Provisional Application No. 62/018,532, filed on Jun. 28, 2014, and titled “Sequential Linear LED Driver Utilizing Headroom Control,” which is incorporated herein by reference in its entirety.

### TECHNICAL FIELD

A sequential linear light emitting diode (LED) driver utilizing a headroom control technique is disclosed.

### BACKGROUND OF THE INVENTION

With reference to FIG. 1, prior art LED system 100 is depicted. LED system 100 comprises a plurality of LED strings. In this example, LED system 100 comprises LED string 110, LED string 120, LED string 130, LED string 140, LED string 150, and LED string 160, each of which comprises a plurality of LEDs. It is to be understood that fewer LED strings can be used or a greater number of LED strings can be used. LED system 100 comprises bridge rectifier 105, which converts an AC signal into a DC signal. Each LED string is associated with a current regulator. In this example, the current regulators comprise current regulator 115, current regulator 125, current regulator 135, current regulator 145, current regulator 155, and current regulator 165.

At the beginning of an AC cycle, the DC voltage output by bridge rectifier 105 will be 0V. Current regulators 115, 125, 135, 145, 155, and 165 will each be placed into the closed (conducting) position. Initially, none of the LEDs in LEDS strings 110, 120, 130, 140, and 150 are emitting light because the input voltage is insufficiently high to forward bias any of the LEDs. As the AC period progresses, the input voltage output by bridge rectifier 105 will increase, and LEDs will become forward biased. When the input voltage is large enough such that the LEDs in LED string 110 are forward biased, then LED string 110 will emit light. When the input voltage is large enough such all LEDs in LED string 110 and LED string 120 are forward biased, then both LED string 110 and LED string 120 will emit light. At that point, current regulator 125 will cause current regulator 115 to open (stop conducting), and all current drawn through LED string 110 and LED string 120 will run through current regulator 125. Similarly, when all LEDs in LED string 130 are forward biased and emit light, current regulator 135 will cause current regulator 125 to open; when all LEDs in LED string 140 are forward biased and emit light, current regulator 145 will cause current regulator 135 to open; when all LEDs in LED string 150 are forward biased and emit light, current regulator 155 will cause current regulator 145 to open; and when all LEDs in LED string 160 are forward biased and emit light, current regulator 165 will cause current regulator 155 to open.

With reference to the graph shown above prior art LED system 100 in FIG. 1, as the input voltage from bridge rectifier 105 increases, the amount of current drawn by each current regulator increases linearly until the next current regulator causes it to open. Thus, when LED string 110 first begins emitting light, the current through current regulator 115 will increase until it is shut off. At that point, the current through current regulator 125 will increase until it is shut off, etc. As can be seen in FIG. 1, a substantial amount of power is dissipated through each current regulator. This is wasted power, as it ends up in increased heat generated by the current regulators and not in light generated by the LEDs.

What is needed is an improved LED system that is more power efficient and reduces the amount of power dissipated through the current regulators.

### SUMMARY OF THE INVENTION

The present invention comprises a sequential linear LED driver whereby the amount of power dissipated through current regulators is decreased compared to the prior art through the use of a headroom control technique.

### BRIEF DESCRIPTION OF THE DRAWINGS

FIG. 1 depicts a prior art sequential linear LED driver and associated power dissipation characteristics.

FIG. 2 depicts an embodiment of a sequential linear LED driver utilizing a headroom control technique and associated power dissipation characteristics.

FIG. 3 depicts power dissipation characteristics of the prior art system of FIG. 1.

FIG. 4 depicts power dissipation characteristics of the system of FIG. 2.

FIG. 5 depicts a control system of headroom control subsystem of FIGS. 2 and 6-9.

FIG. 6 depicts another embodiment of a sequential linear LED driver utilizing a headroom control technique and associated power dissipation characteristics.

FIG. 7 depicts another embodiment of a sequential linear LED driver utilizing a headroom control technique and associated power dissipation characteristics.

FIG. 8 depicts another embodiment of a sequential linear LED driver utilizing a headroom control technique and associated power dissipation characteristics.

FIG. 9 depicts another embodiment of a sequential linear LED driver utilizing a headroom control technique and associated power dissipation characteristics.

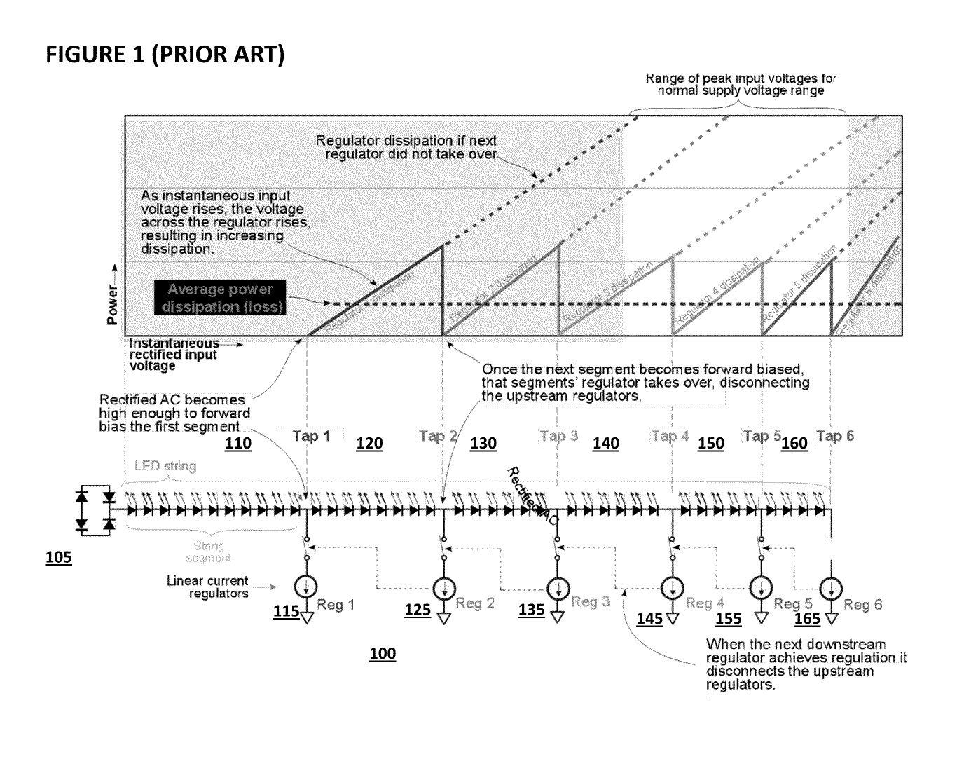

### DETAILED DESCRIPTION OF THE PREFERRED EMBODIMENT

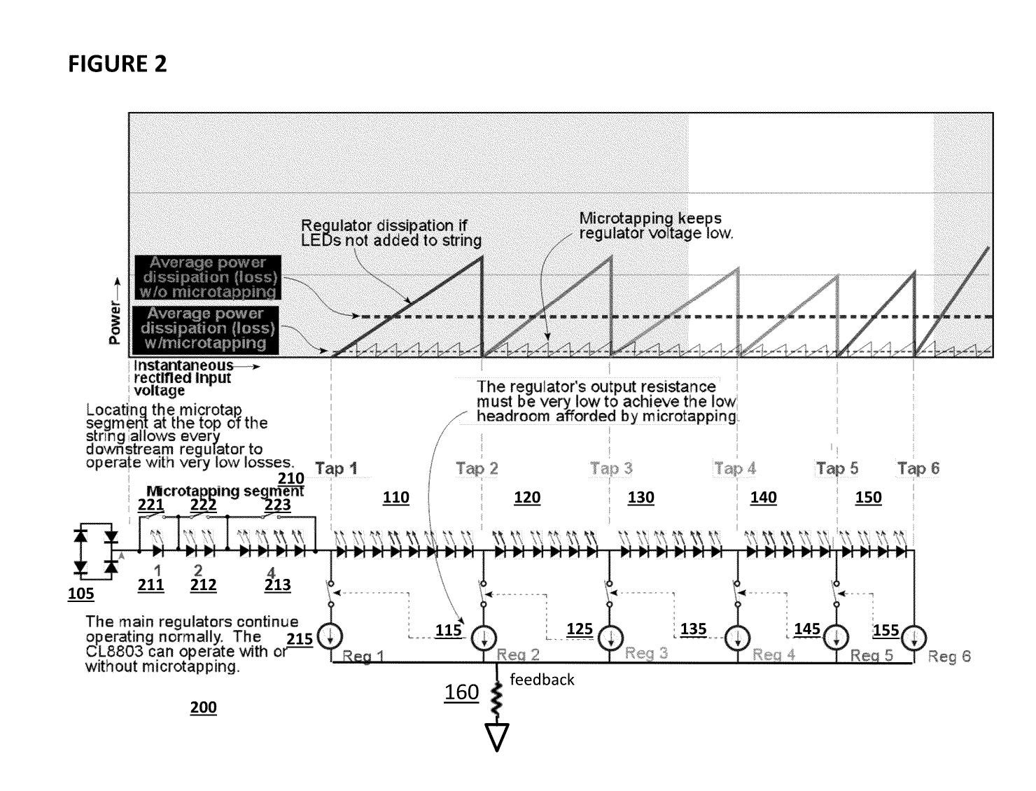

With reference to FIG. 2, LED system 200 is depicted Like prior art LED system 100, LED system 200 comprises bridge rectifier 105, LED strings 110, 120, 130, 140, and 150, and current regulators 115, 125, 135, 145, and 155. Each of the LED strings 110, 120, 130, 140, and 150 each can comprise one LED or a plurality of LEDs connected in series, parallel, or any combination thereof. It is to be understood that fewer LED strings can be used or a greater number of LED strings can be used. Current regulators 151, 152, 153, 154, and 155 are coupled to resistor 160, which in turn is coupled to ground. Thus, current regulators 151, 152, 153, 154, and 155 share a common path to ground.

LED system 200 also comprises headroom control LED segment 210 and current regulator 215. In this example, headroom control LED segment comprises 1-LED segment 211, 2-LED segment 212, and 4-LED segment 213. However, it is to be understood that other numbers of segments (e.g., 1-LED, 2-LED, 3-LED, etc.) each comprising other numbers of LEDs can be used as well. Switch 221 is connected in parallel with 1-LED segment 211, switch 222 is connected in parallel with 2-LED segment 212, and switch 223 is connected in parallel with 4-LED segment 213.

During operation, various combinations of segments within headroom control LED segment 210 are turned on before each of LED strings 110, 120, 130, 140, and 150 is turned on.

For example, at the beginning of the AC cycle, the input voltage from bridge rectifier 105 will start at 0V. Switches 221, 222, and 223 are initially closed. As the AC cycle begins, switch 221 is opened, and 1-LED segment 211 turns on, such that one LED emits light. As the cycle progresses, switch 221 is closed again, and switch 222 is open, such that 2-LED segment 212 emits light. Then switch 221 is opened, switch 222 remains open, and switch 223 remains closed, such that 1-LED segment 221 and 2-LED segment 222 emit light (such that three LEDs are emitting light). Then switch 223 is open and switches 221 and 222 are closed, such that 4-LED segment 223 emits light. In this manner, between one and seven LEDs can be lit up using headroom control segment 210.

When the input voltage is high enough such that LED string 110 is turned on, switches 221, 222, and 223 are closed. Thereafter, LED string 110 remains on, and the same sequence described above (e.g., 1-LED segment 221 is turned on, then 2-LED segment 222, etc.) repeats until LED string 120 turns on, and so on. When LED string 120 turns on, current regulator 115 is shut down to save power, and current regulator 125 thereafter drives LED strings 110 and 120. Similarly, when LED string 130 turns on, current regulator 125 is shut down, when LED string 140 turns on, current regulator 135 is shut down, and when LED string 150 turns on, current regulator 145 is shut down.

The graph shown above LED system 200 depicts power dissipation through the current regulators 115, 125, 135, 145, 155, and 215. Compared to prior art LED system 100, a significantly lower amount of power is dissipated through current regulators. Specifically, more power is dissipated through LEDs (resulting in light) than in prior art LED system 100, due to the use of headroom control segment 210.

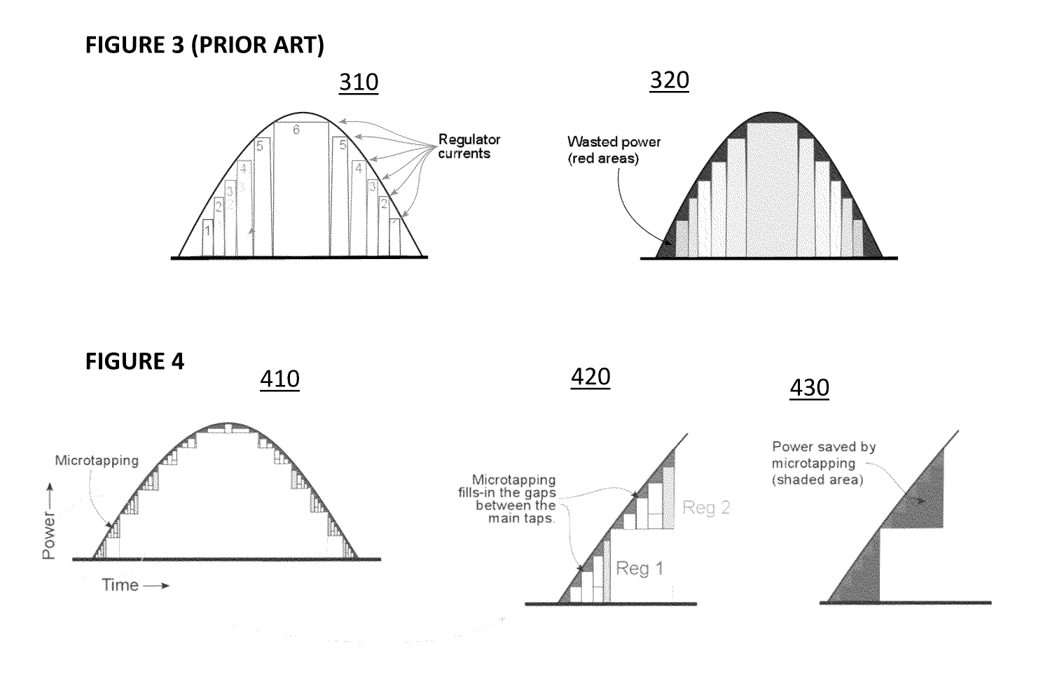

With reference to FIG. 3, graphs 310 and 320 depict for prior art LED system 100 the amount of power dissipated through LEDs (the rectangular areas) and the amount of power dissipated through the current regulators (the areas between the rectangular areas and the sine wave).

By contrast, with reference to FIG. 4, graphs 410, 420, and 430 depict for LED system 200 the amount of power dissipated through LEDs (the rectangular areas) and the amount of power dissipated through the current regulators (the areas between the rectangular areas and the sine wave). As can be seen, LED system 200 is much more power-efficient than prior art LED system 100.

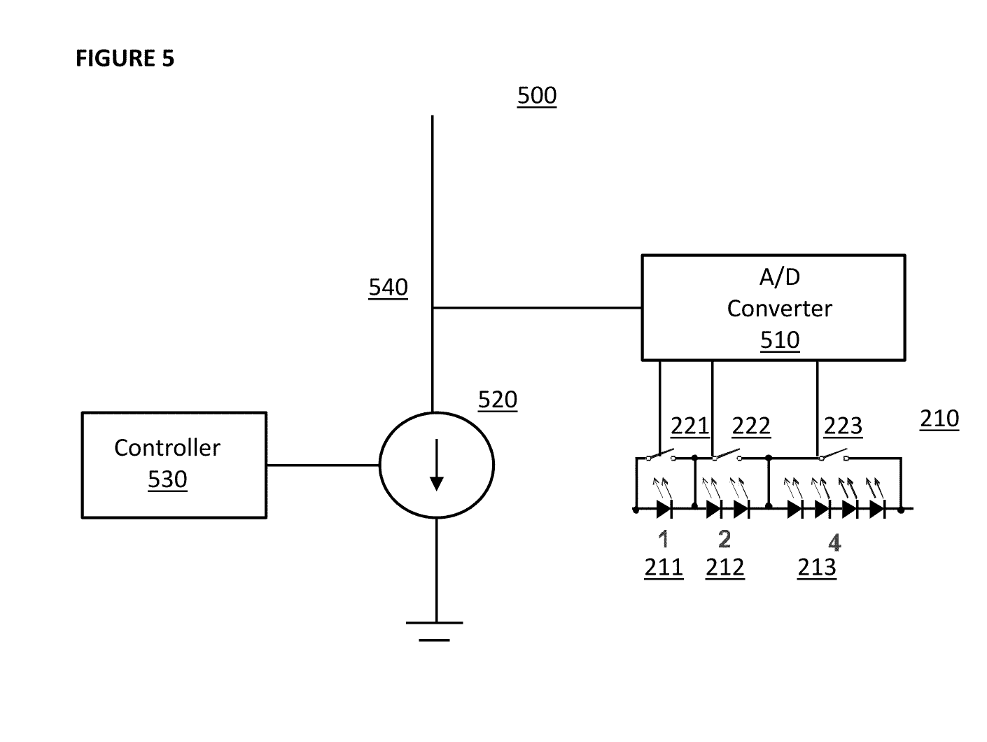

With reference to FIG. 5, an embodiment of control circuitry 500 for headroom control segment 210 is shown. Controller 530 controls the current drawn by current regulator 520, which in turn affects the voltage at node 540. The voltage at node 540 is used to control switches 231, 232, and 233. The voltage at node 540 is input to analog-to-digital converter 510, which converts the analog voltage into a digital signal that is used to control switches 231, 232, and 233. In this example, A/D converter 510 outputs three bits. The first bit (most significant bit) controls switch 233, the second bit controls switch 232, and the third bit (least significant bit) controls switch 231, where a “1” results in the switch being opened. It can be appreciated that as the voltage at 540 increases from 0V, the bit values will also increase, which results in varying combinations of the switched being opened as described above. It will be appreciated that other control mechanisms can be used for headroom control segment 210.

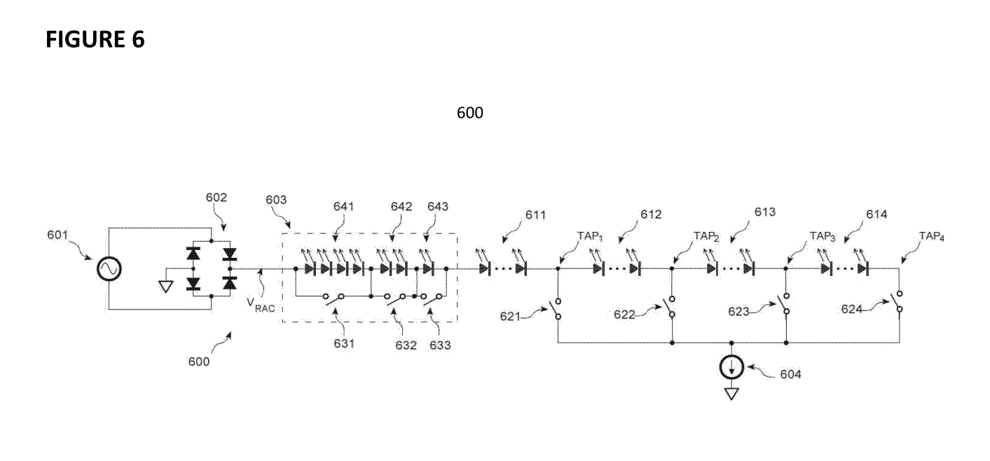

With reference to FIG. 6, LED system 600 is depicted. LED system 600 comprises AC power supply 601, bridge rectifier 602, LED strings 611, 612, 613, and 614, and current regulator 604. Each of the LED strings 611, 612, 613, and 614 each can comprise one LED or a plurality of LEDs connected in series, parallel, or any combination thereof. It is to be understood that fewer LED strings can be used or a greater number of LED strings can be used.

LED system 600 also comprises headroom control LED segment 603. In this example, headroom control LED segment 603 comprises 1-LED segment 643, 2-LED segment 642, and 4-LED segment 641. However, it is to be understood that other numbers of segments (e.g., 1-LED, 2-LED, 3-LED, etc.) each comprising other numbers of LEDs can be used as well. Switch 633 is connected in parallel with 1-LED segment 643, switch 632 is connected in parallel with 2-LED segment 642, and switch 631 is connected in parallel with 4-LED segment 641.

During operation, various combinations of segments within headroom control LED segment 603 are turned on before each of LED strings 611, 612, 613, and 614 is turned on. For example, at the beginning of the AC cycle, the input voltage from bridge rectifier 602 will start at 0V. Switches 633, 632, and 631 are initially closed. As the AC cycle begins, switch 633 is opened, and 1-LED segment 643 turns on, such that one LED emits light. As the cycle progresses, switch 633 is closed again, and switch 632 is open, such that 2-LED segment 642 emits light. Then switch 633 is opened, switch 632 remains open, and switch 631 remains closed, such that 1-LED segment 643 and 2-LED segment 642 emit light (such that three LEDs are emitting light). Then switch 631 is open and switches 633 and 632 are closed, such that 4-LED segment 641 emits light. Opening switches 633 and 631 and closing switch 632 will cause five LEDs to be lit up; opening switches 633 and 632 will cause six LEDs to be lit up; and opening switches 633, 632, and 631 will cause seven LEDs to be lit up. Thus, between one and seven LEDs can be lit up using headroom control segment 603.

When the input voltage is high enough such that LED string 611 is turned on, switches 633, 632, and 631 are closed. Thereafter, LED string 611 remains on, and the same sequence described above (e.g., 1-LED segment 633 is turned on, then 2-LED segment 632, etc.) repeats until LED string 612 turns on, and so on.

Optionally, control circuitry 500 of FIG. 5 can be used with headroom control segment 603.

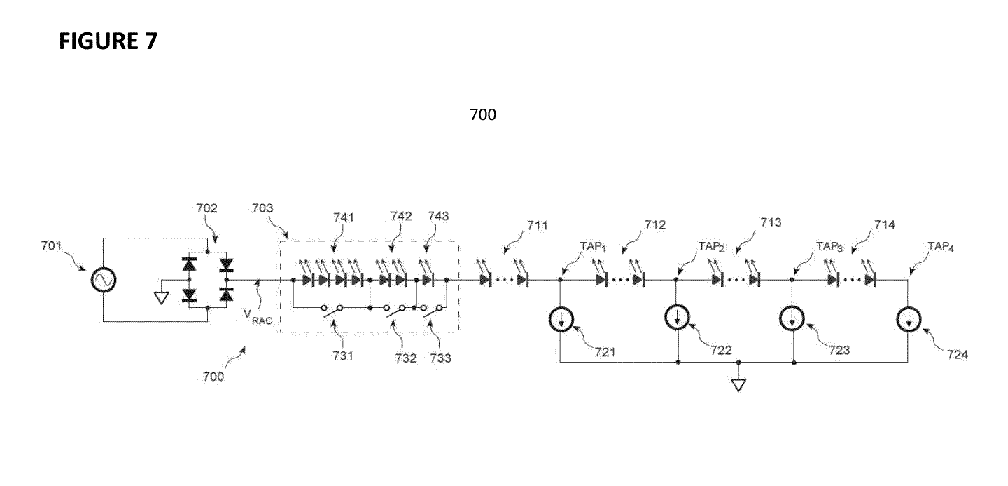

With reference to FIG. 7, LED system 700 is depicted. LED system 700 comprises AC power supply 701, bridge rectifier 702, LED strings 711, 712, 713, and 714, and current regulators 721, 722, 723, and 724. Each of the LED strings 711, 712, 713, and 714 each can comprise one LED or a plurality of LEDs connected in series, parallel, or any combination thereof. It is to be understood that fewer LED strings can be used or a greater number of LED strings can be used.

LED system 700 also comprises headroom control LED segment 703. In this example, headroom control LED segment 703 comprises 1-LED segment 743, 2-LED segment 742, and 4-LED segment 741. However, it is to be understood that other numbers of segments (e.g., 1-LED, 2-LED, 3-LED, etc.) each comprising other numbers of LEDs can be used as well. Switch 733 is connected in parallel with 1-LED segment 743, switch 732 is connected in parallel with 2-LED segment 742, and switch 731 is connected in parallel with 4-LED segment 741.

During operation, various combinations of segments within headroom control LED segment 703 are turned on before each of LED strings 711, 712, 713, and 714 is turned on.

For example, at the beginning of the AC cycle, the input voltage from bridge rectifier 702 will start at 0V. Switches 733, 732, and 731 are initially closed. As the AC cycle begins, switch 733 is opened, and 1-LED segment 743 turns on, such that one LED emits light. As the cycle progresses, switch 733 is closed again, and switch 732 is open, such that 2-LED segment 742 emits light. Then switch 733 is opened, switch 732 remains open, and switch 731 remains closed, such that 1-LED segment 743 and 2-LED segment 742 emit light (such that three LEDs are emitting light). Then switch 731 is open and switches 733 and 732 are closed, such that 4-LED segment 741 emits light. Opening switches 733 and 731 and closing switch 732 will cause five LEDs to be lit up; opening switches 733 and 732 will cause six LEDs to be lit up; and opening switches 733, 732, and 731 will cause seven LEDs to be lit up. Thus, between one and seven LEDs can be lit up using headroom control segment 703.

When the input voltage is high enough such that LED string 711 is turned on, switches 733, 732, and 731 are closed. Thereafter, LED string 711 remains on, and the same sequence described above (e.g., 1-LED segment 733 is turned on, then 2-LED segment 732, etc.) repeats until LED string 712 turns on, and so on. When LED string 712 turns on, current regulator 721 is shut down to save power, and current regulator 722 thereafter drives LED strings 711 and 712. Similarly, when LED string 713 turns on, current regulator 722 is shut down and when LED string 714 turns on, current regulator 723.

Optionally, control circuitry 500 of FIG. 5 can be used with headroom control segment 703.

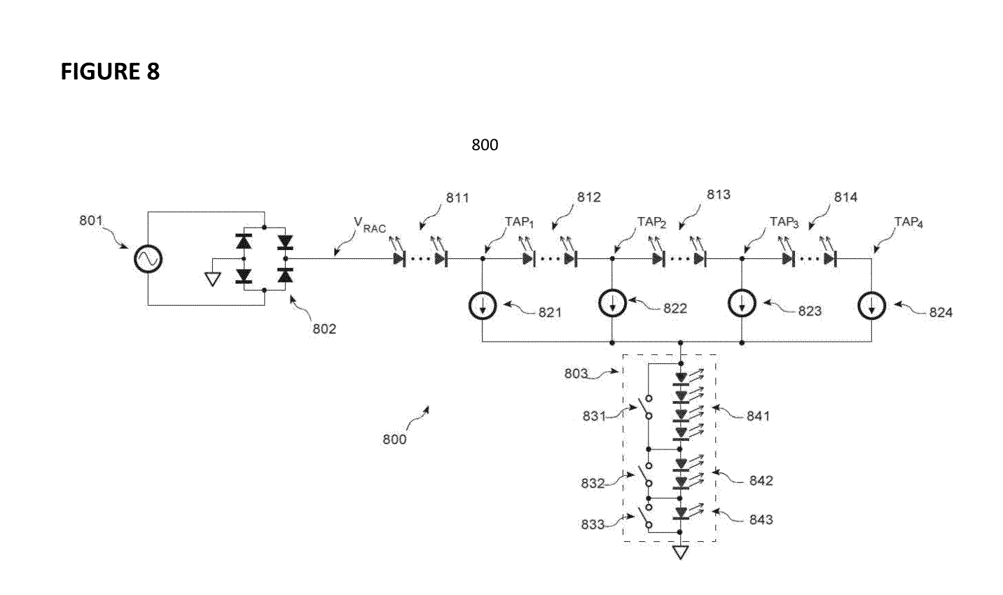

With reference to FIG. 8, LED system 800 is depicted. LED system 800 comprises AC power supply 801, bridge rectifier 802, LED strings 811, 812, 813, and 814, and current regulators 821, 822, 823, and 824. Each of the LED strings 811, 812, 813, and 814 each can comprise one LED or a plurality of LEDs connected in series, parallel, or any combination thereof. It is to be understood that fewer LED strings can be used or a greater number of LED strings can be used.

LED system 800 also comprises headroom control LED segment 803. In this example, headroom control LED segment 803 comprises 1-LED segment 843, 2-LED segment 842, and 4-LED segment 841. However, it is to be understood that other numbers of segments (e.g., 1-LED, 2-LED, 3-LED, etc.) each comprising other numbers of LEDs can be used as well. Switch 833 is connected in parallel with 1-LED segment 843, switch 832 is connected in parallel with 2-LED segment 842, and switch 831 is connected in parallel with 4-LED segment 841.

During operation, various combinations of segments within headroom control LED segment 803 are turned on before each of LED strings 811, 812, 813, and 814 is turned on.

For example, at the beginning of the AC cycle, the input voltage from bridge rectifier 802 will start at 0V. Switches 833, 832, and 831 are initially closed. As the AC cycle begins and current flows through current regulator 821, switch 833 is opened, and 1-LED segment 843 turns on, such that one LED emits light. As the cycle progresses, switch 833 is closed again, and switch 832 is open, such that 2-LED segment 842 emits light. Then switch 833 is opened, switch 832 remains open, and switch 831 remains closed, such that 1-LED segment 843 and 2-LED segment 842 emit light (such that three LEDs are emitting light). Then switch 831 is open and switches 833 and 832 are closed, such that 4-LED segment 841 emits light. Opening switches 833 and 831 and closing switch 832 will cause five LEDs to be lit up; opening switches 833 and 832 will cause six LEDs to be lit up; and opening switches 833, 832, and 831 will cause seven LEDs to be lit up. Thus, between one and seven LEDs can be lit up using headroom control segment 803.

When the input voltage is high enough such that LED string 811 is turned on, switches 833, 832, and 831 are closed. Thereafter, LED string 811 remains on, and the same sequence described above (e.g., 1-LED segment 833 is turned on, then 2-LED segment 832, etc.) repeats until LED string 812 turns on, and so on. When LED string 812 turns on, current regulator 821 is shut down to save power, and current regulator 822 thereafter drives LED strings 811 and 812. Similarly, when LED string 813 turns on, current regulator 822 is shut down and when LED string 814 turns on, current regulator 823.

Optionally, control circuitry 500 of FIG. 5 can be used with headroom control segment 803.

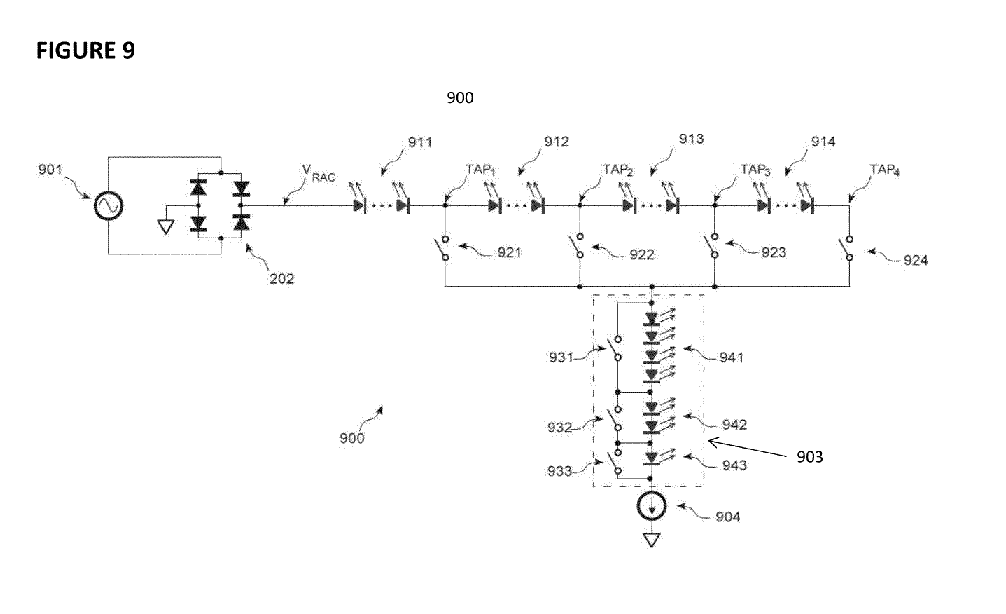

With reference to FIG. 9, LED system 900 is depicted. LED system 900 comprises AC power supply 901, bridge rectifier 902, LED strings 911, 912, 913, and 914, switches 921, 922, 923, and 924, and current regulator 904. Each of the LED strings 911, 912, 913, and 914 each can comprise one LED or a plurality of LEDs connected in series, parallel, or any combination thereof. It is to be understood that fewer LED strings can be used or a greater number of LED strings can be used.

LED system 900 also comprises headroom control LED segment 903. In this example, headroom control LED segment 903 comprises 1-LED segment 943, 2-LED segment 942, and 4-LED segment 941. However, it is to be understood that other numbers of segments (e.g., 1-LED, 2-LED, 3-LED, etc.) each comprising other numbers of LEDs can be used as well. Switch 933 is connected in parallel with 1-LED segment 943, switch 932 is connected in parallel with 2-LED segment 942, and switch 931 is connected in parallel with 4-LED segment 941.

During operation, various combinations of segments within headroom control LED segment 903 are turned on before each of LED strings 911, 912, 913, and 914 is turned on.

For example, at the beginning of the AC cycle, the input voltage from bridge rectifier 902 will start at 0V. Switches 933, 932, and 931 are initially closed. As the AC cycle begins and current flows through current regulator 921, switch 933 is opened, and 1-LED segment 943 turns on, such that one LED emits light. As the cycle progresses, switch 933 is closed again, and switch 932 is open, such that 2-LED segment 942 emits light. Then switch 933 is opened, switch 932 remains open, and switch 931 remains closed, such that 1-LED segment 943 and 2-LED segment 942 emit light (such that three LEDs are emitting light). Then switch 931 is open and switches 933 and 932 are closed, such that 4-LED segment 941 emits light. Opening switches 933 and 931 and closing switch 932 will cause five LEDs to be lit up; opening switches 933 and 932 will cause six LEDs to be lit up; and opening switches 933, 932, and 931 will cause seven LEDs to be lit up. Thus, between one and seven LEDs can be lit up using headroom control segment 903.

Switches 921, 922, 923, and 924 initially are closed. When the input voltage is high enough such that LED string 911 is turned on, switches 933, 932, and 931 are closed. Thereafter, LED string 911 remains on, and the same sequence described above (e.g., 1-LED segment 933 is turned on, then 2-LED segment 932, etc.) repeats until LED string 912 turns on, and so on. When LED string 912 turns on, switch 921 is open. Similarly, when LED string 913 turns on, switch 922 is open, and when LED string 914 turns on, switch 923 is open.

Optionally, control circuitry 500 of FIG. 5 can be used with headroom control segment 903.

What is claimed is:

1. A light emitting diode (LED) system comprising:
a bridge rectifier for generating a direct current voltage from an alternating current voltage;
a headroom control circuit coupled to the bridge rectifier, the headroom control circuit comprising:
one or more sets of one or more LEDs;
one or more switches, wherein each switch is coupled in parallel with one of the one or more sets of LEDs; and
a controller for controlling the one or more switches;
a plurality of LED strings coupled to the headroom control circuit, each of the plurality of LED strings comprising one or more LEDs; and
a plurality of current regulators, each of the plurality of current regulators coupled to one of the plurality of LED strings to control current through that LED string;
wherein the controller is configured to open one or more of the plurality of switches to cause one or more of the one or more sets of LEDs to emit light before the direct current voltage is sufficiently high to cause one or more of the plurality of LED strings to emit light.

2. The system of claim 1, wherein the one or more of sets of LEDs comprises a first set comprising one LED and a second set comprising two LEDs.

3. The system of claim 2, wherein the one or more sets of LEDs further comprises a third set comprising four LEDs.

4. The system of claim 1, wherein the controller comprises an analog-to-digital converter for receiving the direct current voltage and outputting a plurality of bits, each of the plurality of bits used to control one of the one or more switches.

5. A light emitting diode (LED) system comprising:
a bridge rectifier for generating a direct current voltage from an alternating current voltage;
a headroom control circuit coupled to the bridge rectifier, the headroom control circuit comprising:
a plurality of sets of LEDs;
a plurality of switches, wherein each switch is coupled in parallel with one of the plurality of sets of LEDs; and
a controller for controlling the plurality of switches;
a plurality of LED strings coupled to the headroom control circuit, each of the plurality of LED strings comprising one or more LEDs;
a plurality of current regulators, each of the plurality of current regulators coupled to one of the plurality of LED strings to control current through that LED string; and
a resistor coupled to each of the plurality of current regulators to provide a common path to ground;
wherein the controller is configured to open one or more of the plurality of switches to cause one or more the plurality of sets of LEDs to emit light before the direct current voltage is sufficiently high to cause one or more of the plurality of LED strings to emit light.

6. The system of claim 5, wherein the plurality of sets of LEDs comprises a first set comprising one LED and a second set comprising two LEDs.

7. The system of claim 6, wherein the plurality of sets of LEDs further comprises a third set comprising four LEDs.

8. The system of claim 5, wherein the controller comprises an analog-to-digital converter for receiving the direct current voltage and outputting a plurality of bits, each of the plurality of bits used to control one of the plurality of switches.

9. A method of operating a light emitting diode (LED) system comprising a bridge rectifier for generating a direct current voltage from an alternating current voltage; a headroom control circuit coupled to the bridge rectifier, the headroom control circuit comprising a plurality of sets of LEDs, and a plurality of switches, wherein each switch is coupled in parallel with one of the plurality of sets of LEDs; and a plurality of LED strings coupled to the headroom control circuit, each of the plurality of LED strings comprising one or more LEDs, the method comprising:
opening one or more of the plurality of switches to cause the one or more the plurality of sets of LEDs to emit light before the direct current voltage is sufficiently high to cause one or more of the plurality of LED strings to emit light.

10. The method of claim 9, wherein the plurality of sets of LEDs comprises a first set comprising one LED and a second set comprising two LEDs.

11. The method of claim 10, wherein the plurality of sets of LEDs further comprises a third set comprising four LEDs.

12. The method of claim 9, further comprising:
receiving the direct current voltage by an analog-to-digital converter and outputting a plurality of bits, each of the plurality of bits used to control one of the plurality of switches.

13. A method of operating a light emitting diode (LED) system comprising a bridge rectifier for generating a direct current voltage from an alternating current voltage; a headroom control circuit coupled to the bridge rectifier, the headroom control circuit comprising a plurality of sets of LEDs, and a plurality of switches, wherein each switch is coupled in parallel with one of the plurality of sets of LEDs; a plurality of LED strings coupled to the headroom control circuit, each of the plurality of LED strings comprising one or more LEDs; a plurality of current regulators, each of the plurality of current regulators coupled to one of the plurality of LED strings to control current through that LED string; and a resistor coupled to each of the plurality of current regulators to provide a common path to ground, the method comprising:
opening one or more of the plurality of switches to cause the one or more the plurality of sets of LEDs to emit light before the direct current voltage is sufficiently high to cause one or more of the plurality of LED strings to emit light.

14. The method of claim 13, wherein the plurality of sets of LEDs comprises a first set comprising one LED and a second set comprising two LEDs.

15. The method of claim 14, wherein the plurality of sets of LEDs further comprises a third set comprising four LEDs.

16. The method of claim 13, further comprising:
receiving the direct current voltage by an analog-to-digital converter and outputting a plurality of bits, each of the plurality of bits used to control one of the plurality of switches.

17. A light emitting diode (LED) system comprising:
a bridge rectifier for generating a direct current voltage from an alternating current voltage;
a headroom control circuit coupled to the bridge rectifier, the headroom control circuit comprising:
a plurality of sets of LEDs;
a plurality of switches, wherein each switch is coupled in parallel with one of the plurality of sets of LEDs; and
a controller for controlling the plurality of switches;
a plurality of LED strings coupled to the headroom control circuit, each of the plurality of LED strings comprising one or more LEDs; and
a current regulators coupled to one of the plurality of LED strings to control current through the plurality of LED strings;
wherein the controller is configured to open one or more of the plurality of switches to cause one or more the plurality of sets of LEDs to emit light before the direct current voltage is sufficiently high to cause one or more of the plurality of LED strings to emit light.

18. The system of claim 17, wherein the plurality of sets of LEDs comprises a first set comprising one LED and a second set comprising two LEDs.

19. The system of claim 18, wherein the plurality of sets of LEDs further comprises a third set comprising four LEDs.

20. The system of claim 17, wherein the controller comprises an analog-to-digital converter for receiving the direct current voltage and outputting a plurality of bits, each of the plurality of bits used to control one of the plurality of switches.

21. A light emitting diode (LED) system comprising:
a bridge rectifier for generating a direct current voltage from an alternating current voltage;
a plurality of LED strings coupled to bridge rectifier, each of the plurality of LED strings comprising one or more LEDs; and
a plurality of current regulators, each of the plurality of current regulators coupled to one of the plurality of LED strings to control current through that LED string;
a headroom control circuit coupled to the plurality of current regulators, the headroom control circuit comprising:
a plurality of sets of LEDs;
a plurality of switches, wherein each switch is coupled in parallel with one of the plurality of sets of LEDs; and
a controller for controlling the plurality of switches;
wherein the controller is configured to open one or more of the plurality of switches to cause one or more the plurality of sets of LEDs to emit light before the direct current voltage is sufficiently high to cause one or more of the plurality of LED strings to emit light.

22. The system of claim 21, wherein the plurality of sets of LEDs comprises a first set comprising one LED and a second set comprising two LEDs.

23. The system of claim 22, wherein the plurality of sets of LEDs further comprises a third set comprising four LEDs.

24. The system of claim 21, wherein the controller comprises an analog-to-digital converter for receiving the direct current voltage and outputting a plurality of bits, each of the plurality of bits used to control one of the plurality of switches.

25. A light emitting diode (LED) system comprising:
a bridge rectifier for generating a direct current voltage from an alternating current voltage;
a plurality of LED strings coupled to bridge rectifier, each of the plurality of LED strings comprising one or more LEDs;
a plurality of main switches, each of the plurality of main switches coupled to one of the plurality of LED strings; AND
a headroom control circuit coupled to the plurality of current regulators, the headroom control circuit comprising:
a plurality of sets of LEDs;
a plurality of headroom switches, wherein each headroom switch is coupled in parallel with one of the plurality of sets of LEDs; and
a controller for controlling the plurality of headroom switches;
wherein the controller is configured to open one or more of the plurality of headroom switches to cause one or more the plurality of sets of LEDs to emit light before the direct current voltage is sufficiently high to cause one or more of the plurality of LED strings to emit light.

26. The system of claim 25, wherein the plurality of sets of LEDs comprises a first set comprising one LED and a second set comprising two LEDs.

27. The system of claim 26, wherein the plurality of sets of LEDs further comprises a third set comprising four LEDs.

28. The system of claim 25, wherein the controller comprises an analog-to-digital converter for receiving the direct current voltage and outputting a plurality of bits, each of the plurality of bits used to control one of the plurality of headroom switches.
